(19) United States
(12) Patent Application Publication
(10) Pub. No.: US 2010/0263736 A1
(43) Pub. Date: Oct. 21, 2010

(54) DEVICE FOR INJECTING AN ADDITIVE INTO A PIPE

(76) Inventor: Eric Issartel, Vouneuil Sur Vienne (FR)

Correspondence Address: Oliff & Berridge, PLC, P.O. Box 320850, Alexandria, VA, 22320-4850, US

(21) Appl. No.: 12/667,968

(22) PCT Filed: Jul. 10, 2008
(86) PCT No.: PCT/FR08/51288

§ 371 Date: Jun. 23, 2010

(30) Foreign Application Priority Data
Jul. 11, 2007 (FR) 07 56422

(51) Int. Cl. G05D 11/00; B23P 23/00

(52) U.S. Cl. 137/101.19; 29/401.1

(57) ABSTRACT

The invention relates to a storage and metering device intended for the injection of an additive into a pipe through which a variable-flow-rate liquid flows. The device is characterized in that it includes: a container intended to house the additive and provided with an additive outlet to be connected to the pipe, optionally by means of an injection system; and a differential pressure regulator including a gas inlet to be connected to a gas source, a gas outlet connected to a pressurization inlet of the container so that the container can be pressurized to a pressurization pressure and a control inlet to be connected to the pipe.

The present invention relates to a method and a device for injecting an additive into a pipe through which a variable-flow-rate liquid flows, in particular to control the concentration of an emulsifier in a stream of water feeding a sprinkler network.

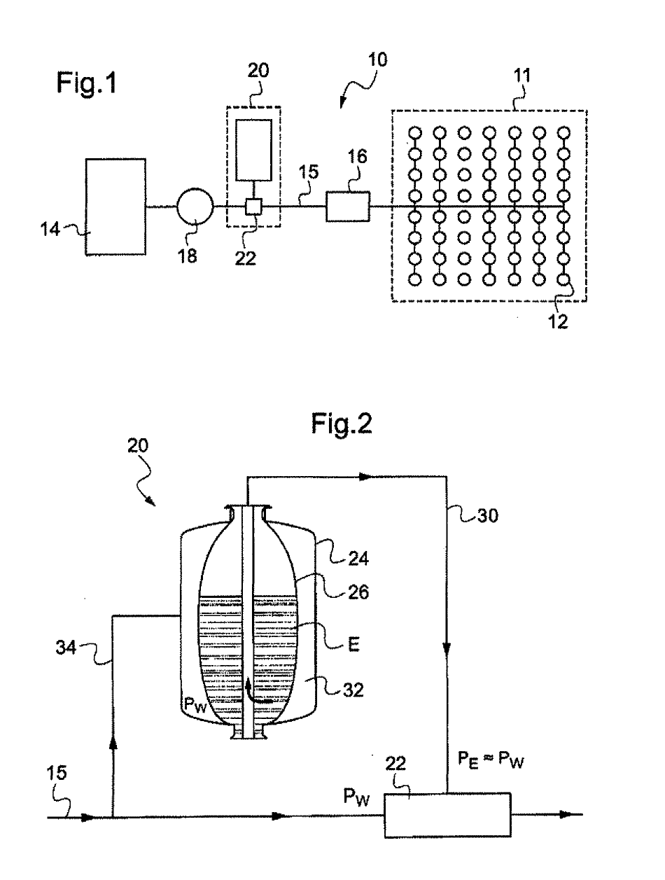

Sprinkler networks are conventionally used in the context of fire protection of buildings. Such a network 10, as shown in FIG. 1, conventionally comprises a set 11 of sprinklers 12 communicating fluidly with a water reserve 14, via a pipe 15, in which a control station 16 and a feed pump 18 are inserted. A sprinkler 12 is conventionally closed by a fusible element, for example a glass bulb, which melts when the ambient temperature is abnormally high, for example between 68 and 500° C. The control station 16 detects any depressurization resulting from the rupture of one or more sprinkler fuses and, accordingly, establishes the communication with the water reserve 14 and starts the pump 18.

Water is thereby sprayed into the room where the triggered sprinkler is installed.

The pipe 15 and the water reserve 14 are suitable for supplying water to the set 11 of sprinklers at a variable flow rate and pressure according to the number of sprinklers triggered, the flow rate generally remaining substantially proportionate to the square root of the pressure.

For example, the feed pressure is conventionally between 3 and 10 bar and the flow rate between 400 and 2400 l/min, according to the number of sprinklers triggered, when the pipe has a diameter of 100 mm.

Still conventionally, an emulsifier is injected into the sprayed water by means of a storage and metering unit 20 via an injection system 22, or proportioner inserted on the pipe 15 upstream of the control station 16.

As shown in FIG. 2, the storage and metering unit 20 conventionally comprises a metal container 24 in which a flexible bag 26 containing an additive, for example an emulsifier E is placed. The flexible bag 26 communicates fluidly with the injection system 22 via an additive line 30. The space 32 between the flexible bag 26 and the container 24 communicates fluidly with the pipe 15 via a pressurization line 34. The space 32 is thus filled with water, substantially at the pressure P_{w} of the water in the pipe 15 upstream of the injection system 22. The pressure P_{E} in the additive line 30 upstream of the injection system 22 is thus substantially equal to the pressure P_{w}.

The injection system 22, generally a Venturi effect system, serves to inject emulsifier E at a rate commensurate with the flow rate of water passing through it. Thus, as the water flow rate increases due to the increase in the number of triggered sprinklers, the quantity of injected emulsifier increases. The emulsifier concentration in the water sprayed by the sprinklers is thus substantially constant.

The flexible bag 26 may however be perforated, in particular by aging or friction against the weld burrs or on the vents of the container 24, in particular under the effect of water hammer. This problem is particularly serious because a leak is not easily detectible and affects the operation of the unit 20.

Furthermore, the bag 26 must be reconditioned after use, implying the action of a specialist and long-term maintenance out of service.

A need therefore exists for a method and a device for solving one or more of the abovementioned problems.

It is the object of the invention to satisfy this need.

According to the invention, this object is achieved by means of a storage and metering device for injecting an additive into a pipe through which a variable-flow-rate liquid flows, the device comprising
a container for containing said additive and provided with an additive outlet to be connected to the said pipe, optionally by means of an injection system, and
a differential pressure controller comprising a pressurization fluid inlet to be connected to a source of said pressurization fluid, a pressurization fluid outlet connected to a pressurization inlet of the container so as to be able to pressurize said container to a pressurization pressure, and a control inlet to be connected to the pipe.

Thus, the pressure of the injected additive, for example an emulsifier, is no longer obtained by the pressure of the liquid flowing in the pipe, for example water, on a flexible bag containing this additive, but by the pressure of a pressurization fluid pressurizing a container containing said additive. Advantageously, the flexible bag of the storage and metering units of the prior art can therefore be eliminated. The reliability is thereby increased and maintenance is simplified.

After connection to the pipe, preferably upstream of the additive injection point, the pressure at the control inlet, or control pressure, is substantially equal to the liquid pressure at the connection point. Preferably, the controller is arranged so that the pressurization pressure is substantially equal to the control pressure. The additive pressure upstream of the injection point, substantially equal to the pressurization pressure, is therefore substantially equal to the liquid pressure upstream of the injection point, thereby enabling the additive injection flow rate to vary with the liquid flow rate in the pipe preferably so as to remain substantially proportional to said liquid flow rate.

In a more general embodiment, the controller is arranged so that the pressurization pressure is substantially equal to a pressure setpoint equal to the control pressure modified by an offset pressure. Preferably, the controller is arranged to allow an adjustment, for example manual, of the offset pressure to a value that is preferably constant over time. Advantageously, it is thereby possible to take account of the nature, and in particular the viscosity, of the additive. This adaptation is advantageously rapid and independent of the injection system used at the injection point.

Still preferably, the controller comprises means for controlling the pressurization pressure in order to minimize the difference between the control pressure or the pressure setpoint and a pressure of the additive measured upstream of the injection point in the pipe, in particular in an additive line connecting the additive outlet of the container and said pipe, preferably immediately next to the injection point. For this purpose, the controller may comprise a return inlet connected to the additive line close to the injection point, and comparison means for evaluating the difference between the control pressure or the pressure setpoint and the pressure at the return inlet, the controller modifying the pressurization pressure so as to minimize this difference.

Still preferably, the controller is a mechanical controller, involving no electrical or electronic member. The reliability of the device is further improved.

The use of a controller comprising a micro-controller is however also feasible.

Preferably, the storage and metering device of the invention comprises an injection system at the injection point in the pipe. The injection system may be connected to said container outlet via an additive line and be inserted into the pipe in order to inject said additive therein. This injection system may in particular be an automatic proportioner, that is purely mechanical. The injection system may in particular comprise means for accelerating the additive streams and the liquid passing through it. For example, it may comprise first and second diaphragms reducing the flow passages of said liquid and of said additive, respectively.

In one embodiment, the injection system is arranged so that when the pressures of said liquid and of said additive upstream of said injection system are substantially equal, the injected additive flow rate is substantially proportional to the liquid flow rate in said pipe.

The storage and metering device according to the invention may further comprise a shutoff valve for selectively closing or opening the communication between the pressurization fluid inlet of the controller and the pressurization fluid source.

Preferably, the shutoff valve is controlled, for example according to a flow rate or a pressure, to open in case of liquid flow in the pipe or in case of variation of a liquid pressure in this pipe.

In an application to a sprinkler network, the shutoff valve may be controlled in order to open in case of detection, for example by a control station, of a negative pressure or water flow in the network corresponding to the triggering of a sprinkler. Outside the additive injection phases, the controller and the container may thus not be maintained under pressure thereby advantageously limiting the risks of leakage and the maintenance costs.

Still more preferably, the storage and metering device according to the invention comprises a valve integrated in the upper portion of the container wall, said valve being opened when the gas pressure P_{G} in the container exceeds an opening pressure Pₒ equal to the sum of the liquid pressure P_{W} in the pipe and a pressure differential ΔP, and closed when the gas pressure P_{G} in the container is lower than the opening pressure Pₒ.

Advantageously, this valve allows a rapid adjustment of the additive injection rate in case of a sudden decrease in the liquid pressure P_{W}. Such a decrease in the liquid pressure in the pipe therefore does not cause a durable increase in the additive concentration in the liquid downstream of the injection point.

The additive contained in the container may be selected from the group formed by an emulsifier, a wastewater treatment product, a pool water treatment product and a phytosanitary product.

The invention also relates to a device for feeding a liquid containing an additive, this device comprising:
a pipe connected to a source of said liquid, and
a storage and metering device according to the invention comprising an injection system inserted into said pipe, and whereof the control inlet of the controller is connected to said pipe, preferably upstream of the injection system, still more preferably close to the injection system.

This feed device may comprise a source of pressurized pressurization fluid connected to the pressurization fluid inlet of the controller, the pressurization fluid being a gaseous or non-gaseous fluid. The pressurization fluid source may, for example, be selected from a compressed gas network, a pressurized cylinder or a compressor. The gas may be nitrogen in particular.

The pipe may be a pipe of a fire protection and fighting system, in particular of a system feeding at least one sprinkler, a pipe of a wastewater or pool water treatment installation or a farm sprinkler pipe.

In one embodiment, the storage and metering device, or the feed device, according to the invention, has a size and weight allowing its mounting on board a motor, air or floating vehicle, for example a car or a truck, or is transportable by a person, for example on the back or by hand. In particular for cases in which the storage and metering device, or feed device is intended to be mounted or to be carried by a person, the additive container and/or liquid source may be a container having a capacity lower than 50 liters, or even lower than 20 liters. The liquid source may also consist of a supply network, for example the public water mains.

The invention further relates to a method for controlling the concentration of an additive in a liquid flowing in a pipe at a variable flow (over time) rate, said method comprising an injection at an injection point on said pipe, of said additive at a variable flow rate according to the difference in pressures of the liquid and of the additive upstream of the injection point. According to the invention said additive pressure is modified by modifying the pressure of a pressurization fluid of a container containing said additive and communicating fluidly with said injection point.

The pressure of the pressurization fluid can be determined according to:
a pressure of said liquid in the pipe, in particular upstream of said injection point, and/or
an offset pressure, preferably adjustable, and/or
a pressure of the additive upstream of the injection point, preferably immediately upstream of the injection point.

In a particular embodiment, the pressurization pressure can be modified according to a difference between the additive pressure upstream of the injection point and the liquid pressure in the pipe upstream of the injection point, optionally modified by the offset pressure so as to minimize this difference. Advantageously, this feature serves in particular to compensate for a variation in the additive pressure between the container and the injection point.

The invention relates further to a method for renovating a storage and metering unit for injecting an additive into a pipe through which a liquid flows, the unit comprising
a container of which an inlet can be made to communicate fluidly with said pipe,
a flexible bag for containing said additive, placed inside the container so as to undergo the pressure exerted by said liquid when said container inlet communicates with said pipe, and whereof an outlet can be made to communicate fluidly with said pipe, in particular by means of an injection system inserted into said pipe.

According to the invention this method comprises the following steps:
a) detaching and extracting the bag from the container,
b) modifying the container inlet(s) and outlet(s) and installing a differential pressure controller, and optionally a pressure source, in order to constitute a storage and metering device according to the invention or a feed device according to the invention.

Advantageously, this method serves to re-use a portion of the parts and connections of a metering and injection device or a feed device of the prior art, in particular like the one described in the introduction.

In one embodiment, in step b), the pressurization fluid inlet of the differential pressure controller is connected to a pressurization fluid source, and the pressurization fluid outlet of this controller is connected to a container inlet, preferably in the upper part of the container.

If necessary, a controller return inlet is connected to the additive line, preferably close to the injection system.

Finally, the control inlet of the controller is connected to the pipe, preferably upstream of the injection point. The other orifices causing the container to communicate with the exterior are closed, at least temporarily. After step b), the container is filled, at least partly, with additive. The controller is then capable of modifying the pressurization pressure of the container according to a control pressure corresponding substantially to the liquid pressure in the pipe.

If necessary, the renovation method comprises a step of adjusting an offset pressure of the controller, for example according to the type of additive, and in particular its viscosity, this offset pressure, positive or negative, being added to the control pressure to modify the pressure setpoint of the controller.

In the storage and metering device according to the invention, as in the control method according to the invention, the pressurization fluid may be a gaseous fluid or a non-gaseous fluid, preferably immiscible with the additive. Advantageously, the pressurization of the container with a non-gaseous fluid, that is an incompressible fluid, does not cause a substantial increase in the internal energy of the device according to the invention. The use of incompressible pressurization fluids also advantageously serves to limit the regulatory technical inspections, and in particular to avoid the trials to which containers pressurized with a gas are subjected. If the additive is aqueous, the pressurization fluid may advantageously be hydrophobic. Silicone or a fluorinated solution are feasible for example.

Other features and advantages of the invention will appear from a reading of the detailed description that follows and the examination of the appended drawing in which:

FIG. 1 is a schematic representation of a conventional sprinkler network,

FIG. 2 shows a storage and metering unit of the prior art,

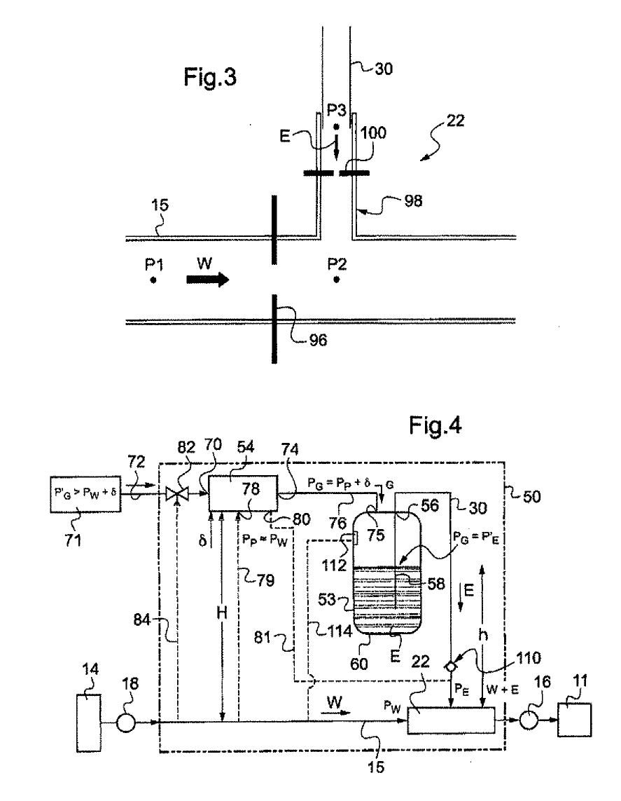

FIG. 3 schematically shows a storage and metering device according to the invention,

FIG. 4 schematically shows a cross section of an injection system which can be used in a storage and metering device according to the invention, and

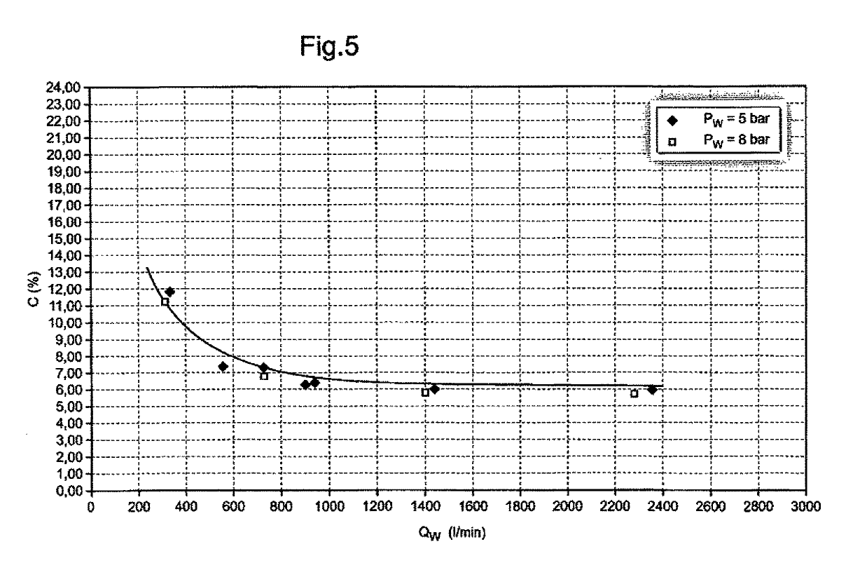

FIG. 5 shows the variation in the additive concentration as a function of the liquid flow rate, downstream of the injection point, the pressure in the pipe, upstream of the injection point, being 6 bar, and the additive being injected by means of a storage and metering device according to the invention.

In the description that follows, identical reference numerals are used to designate identical or similar members.

In FIG. 3, the lines 79 and 81, 84 and 114 are shown by a dotted line because they serve to control the controller 54, the shutter valve 82 and the valve 112, respectively.

FIGS. 1 and 2 having been described in the introduction, reference is made to FIG. 3. This figure shows a storage and metering device 50 according to the invention for supplying water containing emulsifier to a set of sprinklers. Like the storage and metering units of the prior art, the device 50 according to the invention is inserted into a water pipe 15 connected upstream, by means of a pump 18, to a liquid source 14, for example a water tank, and downstream to a set 11 of sprinklers, via a control station 16.

The device 50 comprises a container 53 containing emulsifier E, a differential pressure controller 54 and an injection system 22 for injecting emulsifier E from the container 53 into the pipe 15.

The container 53 may be identical to the container 24 of the storage and metering units in the prior art (FIG. 2). Preferably, it has a capacity of between 200 and 12,000 liters, in particular in an application to a sprinkler network.

An additive outlet 56 of the container 53 is connected to the injection system 22 via an additive line 30. The additive line 30 extends into the container 53 by an immersion tube 58 extending substantially to the bottom 60 of the container in order to extract the emulsifier E contained in the lower portion of the container 53.

The differential pressure controller 54 is connected
by a pressurization fluid inlet, in this case a gas inlet 70, to a pressurization fluid source, in this case a gas source 71, for example a compressed air network or pressurized cylinders, via a gas feed line 72;
by a pressurization fluid outlet, in this case a gas outlet 74, to a pressurization inlet 75 arranged in the upper portion of the container 53, via a pressurization line 76;
by a control inlet 78 to the water pipe 15, via a control line 79.

The type of pressurized gas supplied by the gas source 71 is not limiting. In particular, this gas may be carbon dioxide, nitrogen or compressed air. Preferably, the gas is selected to be insoluble in water. Nitrogen is preferred of all gases.

In one embodiment, the controller 54 is arranged so as to servocontrol the pressurization pressure P_{G} of the gas G at the gas outlet 74 to the control pressure Pₚ at the control inlet 78, the control pressure Pₚ being substantially equal to the pressure P_{w} of the water flowing in the pipe 15. The pressure P′_{G} in the gas source 71 must therefore be higher than the pressure P_{w} in the pipe 15.

In another more general embodiment, the pressure P_{G} at the gas outlet 74 is equal to a pressure setpoint P_{C} equal to the sum of the control pressure Pₚ and a differential that is constant over time, or offset pressure δ, preferably modifiable manually, positive or negative. Advantageously, the storage and metering device according to the invention can adapt easily to a change in viscosity of the additive, by a simple adjustment of the offset pressure δ. The pressure P′_{G} in the gas source 71 must then be higher than the pressure setpoint P_{C}.

Preferably, the controller 54 comprises a return inlet 80, connected, via a return line 81, to the additive line 30, preferably close to the injection system 22, and means for controlling the pressurization pressure to minimize the difference between the return inlet pressure 80 and the control pressure or the pressure setpoint.

Preferably, the controller 54 operates without an external power input.

In the embodiment shown, a shutoff valve 82 is inserted into the gas feed line 72. The shutoff valve 82 is controlled by the water pressure P_{w} in the pipe 15. For this purpose, it has an inlet connected, via a control line 84, to the water pipe 15. As an alternative, the shutoff valve 82 may be opened by hand or be controlled by an electronic or pyrotechnical servercontrol. Preferably, it opens automatically if the pressure drops in the pipe 15 or if water flows therein. Still more preferably, it is arranged to close automatically when none of these two conditions are satisfied. Advantageously, a leak downstream of the valve 82 therefore does not cause a drainage of the gas source 71.

The injection system 22 may be a conventional venturi effect injection system. In this case, without external power input, it allows the injection of emulsifier E into the pipe 15 at a flow rate that depends on the pressure P_{E} of the emulsifier in the additive line 30. The injection system 22 may in particular be arranged to provide an emulsifier injection flow rate substantially proportionate to the square root of the pressure P_{E}. The proportionality constant depends in particular on the diameter of the pipe, the pressure drops, etc.

FIG. 3 shows a schematic longitudinal cross section of an example of an injection system 22. This device comprises a “water” diaphragm 96 partially closing the pipe 15 by opposing the water flow (arrow W). Downstream of this diaphragm, the injection system comprises a branch line 98 for injecting emulsifier (arrow E) into the water stream. This branch line itself comprises an “emulsifier” diaphragm 100 and is connected to the additive outlet 56 of the container 53 by the additive line 30. The “water” and “emulsifier” diaphragms are intended to accelerate the water and emulsifier streams, so that the pressure downstream of these diaphragms (point P2) is lower than the pressures of water (point P1) and of emulsifier (point P3) upstream of the “water and “emulsifier” diaphragms, respectively. Theoretically, such a device serves to obtain an emulsifier concentration in the water stream that is substantially constant downstream of the branch line 98 provided that the emulsifier pressure P_{E} at point P3 remains substantially identical to the water pressure P_{W} at point P1. a calibration of the diaphragm openings, and particularly of the “emulsifier” diaphragm serves to adjust the emulsifier concentration in the water so that, in an application to a sprinkler network, a concentration is obtained that is generally between 3 and 6% by volume, provided that the water flow rate varies within a limited range.

Preferably, the device according to the invention further comprises a nonreturn valve 110 preventing the return of water flowing in the pipe 15 to the emulsifier container 53.

Preferably, the device according to the invention also comprises a valve 112 inserted into the wall of the container 53 at a level enabling it to remain in contact with the gas in the container 53. The valve 112 is connected, via a control line 114 to the pipe 15. The valve 112 is configured to be closed or opened according to whether the pressure P_{G} of the gas in the container 53 is lower or higher, respectively than an opening pressure Pₒ equal to the sum of the pressure P_{W} of the liquid in the pipe 15 and a pressure differential ΔP defined by the user, for example equal to 1 bar.

In case of a sudden drop in pressure P_{W} in the pipe 15, for example due to the use of a fire hose, the valve 112 detects that the difference between the pressures P_{G} and P_{W} exceeds the predefined differential ΔP. The valve then opens, allowing gas contained in the container 53 to escape to the exterior. The pressure P_{G} in the container then decreases very rapidly, allowing a virtually immediate adjustment of the emulsifier pressure P_{E} and thereby avoiding an excessive injection of additive into the liquid of pipe 15.

When the gas pressure P_{G} in the container 53 reaches the opening pressure Pₒ P_{W}+ΔP, the valve closes and the control process continues normally.

The valve 112 thereby allows a rapid decrease in the pressure P_{G} in case of a sudden drop in the pressure P_{W}. In the absence of such a valve, the pressure P_{G} could only decrease by removing additive via the additive line 30. The decrease in the pressure P_{G} would therefore take considerable time and cause an excessive and durable injection of additive into the liquid flowing in the pipe 15.

The operation of the storage and metering device described above is as follows:

In case of fire, the temperature near the sprinklers 12 increases until one or more fusible elements melts. This causes a depressurization downstream of the control station 16. The latter then orders a communication of the sprinklers 12 with the water source 14 and the starting of the pump 18. The pipe 15 is then pressurized, causing the shutoff valve 82 to open.

The controller 54 then modifies the pressurization pressure P_{G} of the container 53 so that it is substantially equal to the pressure setpoint P_{C}, equal to the sum of the control pressure Pₚ, in this case substantially equal to the pressure P_{W} of the water in the pipe 15, and the offset pressure δ. The gas source 71 at a pressure P′_{G} supplies the gas required for this pressurization.

The pressure P′_{E} of the emulsifier E at the interface with the gas G is then equal to the pressure P_{G}. This pressure pushes the emulsifier E into the immersion tube 58, the additive line 30, the nonreturn valve 110 and the injection 22 system. The pressure P_{E} of the emulsifier at the inlet of the injection system 22 is then substantially equal to the pressure P_{W} of the water at the inlet of this device, possibly offset by the offset pressure δ.

When the pressure P_{W} in the pipe 15 changes, particularly due to a change in the number of sprinklers triggered, the controller 54 accordingly instantaneously modifies the pressurization pressure P_{G} of the container 53, without external power input. The emulsifier pressure P_{E} upstream of the injection system 22 therefore always remains substantially equal to the pressure P_{W}, possibly offset by the offset pressure δ, regardless of the change in pressure or water flow rate in the pipe 15, thus guaranteeing an emulsifier concentration “c” that is substantially constant in the water+emulsifier (W+E) mixture sprayed by the sprinklers.

Furthermore, the pressure at the return inlet 80 enables the controller to compare the pressure setpoint P_{C} (=P_{P}+δ) and P_{E}, and, in case of nonzero difference, accordingly to modify P_{G} to decrease this difference. The quality of the control is thereby improved. In particular, this control serves to take account of the pressure differential resulting from the difference in height “h” between the level of the emulsifier in the container and the “emulsifier” diaphragm 100, the pressure drops between the outlet of the container 53 and the “emulsifier” diaphragm 100 and, for low flow rates in particular, a possible pressure differential inherent in the controller, for example 0.1 bar, between the pressurization pressure P_{G} at the controller outlet and the pressure setpoint P_{C}.

Furthermore, the adjustment of the offset pressure makes it possible, if necessary, to maintain a difference between the additive and liquid pressures upstream of the injection system. Advantageously, the offset pressure thus allows an adaptation to a new emulsifier without altering the injection system, and in particular without replacing the diaphragm.

As shown in FIG. 5, the inventive device serves to obtain an emulsifier concentration “c” in the water that is substantially constant for a flow rate between 400 and 2400 l/min, in particular under the operating conditions of a fire protection and fighting device using a sprinkler network.

As it now clearly appears, the invention provides a reliable and inexpensive solution. This solution has the advantage of simplicity, since no flexible bag or external power input is indispensable. The absence of a flexible bag also makes reconditioning much simpler.

Advantageously, the storage and metering device according to the invention can be fabricated by renovating a storage and metering device of the prior art. For this purpose, the operator detaches and removes the bag from the container. He then modifies the inlets and outlets thereof so that the container is a sealed chamber having an outlet 56 allowing the transfer of emulsifier contained in the container 53 to the injection system 22, and a gas inlet 75 arranged preferably in the upper part of the container and allowing the pressurization of the emulsifier.

For this purpose, the operator installs a differential pressure controller of which he connects a gas inlet 70 to a gas source 71, a gas outlet 74 to the inlet 75 of the container 53 and a control inlet 78 to the pipe 15.

The renovation method according to the invention thereby advantageously serves to re-use the injection system of the storage and metering device already in place, and also the container which contained the flexible bag. The production and installation costs are thereby substantially reduced.

Obviously, the invention is not limited to the embodiments described and shown.

In particular, if the storage and metering device according to the invention can be used in the context of a fire protection device, the additive being an emulsifier in particular, it can also be used in other applications, and particularly for the treatment of wastewater or pool water, or in agricultural applications, for example to spray dilute phytosanitary products. The additive is then a product for treating wastewater or pool water or a phytosanitary product.

The expression “comprising a” must be understood here as being synonymous with “comprising at least a” unless otherwise specified.

Furthermore, the immersion tube is optional. For example, the additive outlet 56 can be placed at the bottom of the container. Preferably, this outlet is then equipped with a valve, for example a ball valve, for closing the additive line when all the emulsifier has been consumed. Advantageously, any injection of gas into the pipe is thereby prevented.

The valve may for example be controlled by means of a float floating in the container on the surface of the additive. The control inlet could also be connected downstream of the additive injection point.

1. A storage and metering device for injecting an additive into a pipe through which a variable-flow-rate liquid flows, said device comprising:
a container for containing said additive and provided with an additive outlet for connection to said pipe,
a differential pressure controller comprising a pressurization fluid inlet to be connected to a source of said pressurization fluid, a pressurization fluid outlet connected to a pressurization inlet of the container so that said container can be pressurized to a pressurization pressure, and a control inlet to be connected to said pipe in order to be able to modify the pressurization pressure of said container according to the liquid pressure in the pipe.

2. The device as claimed in claim 1, in which the controller is arranged so that the pressurization pressure is substantially equal to the control pressure at the control inlet, or to a pressure setpoint equal to the control pressure modified by an offset pressure.

3. The device as claimed in claim 1, in which the offset pressure is adjustable.

4. The device as claimed in claim 1, the controller being a mechanical controller not involving any electrical or electronic member.

5. The device as claimed in claim 1, comprising, at the injection point of the pipe, an injection system comprising first diaphragms reducing the flow passages of said liquid and of said additive, respectively.

6. The device as claimed in claim 2, in which the controller comprises means for controlling the pressurization pressure in order to minimize the difference between the control pressure or the pressure setpoint and a pressure of the additive measured upstream of the injection point in the pipe.

7. The device as claimed in claim 1, comprising a shutoff valve for selectively closing or opening the communication between the pressurization fluid inlet and the pressurization fluid source.

8. The device as claimed in claim 1, the container containing an additive selected from the group formed by an emulsifier, a wastewater treatment product, a pool water treatment product and a phytosanitary product.

9. The device as claimed in claim 1, arranged so as to be able to be mounted on board a motor, air or floating vehicle, or to be transportable by a person.

10. The device for feeding a liquid containing an additive, comprising
a pipe connected to a source of said liquid, and
a storage and metering device as claimed in claim 1 and comprising an injection system inserted into said pipe, and whereof the control inlet of the controller is connected to said pipe.

11. The device as claimed in claim 10, comprising a source of pressurized pressurization fluid connected to the pressurization fluid inlet of said controller, the pressurization fluid being a gaseous or incompressible fluid.

12. The device as claimed in claim 11, the pressurization fluid source being selected from a compressed gas network, a pressurized cylinder, a compressor.

13. The device as claimed in claim 10, the pipe being a pipe of a fire protection and fighting system comprising at least one sprinkler.

14. The device as claimed in claim 10, the control inlet being connected upstream of the additive injection point in the pipe.

15. A method for controlling the concentration of an additive in a liquid flowing in a pipe at a variable flow rate, said method comprising an injection at an injection point on said pipe, of said additive at a variable flow rate according to the difference in pressures of the liquid and of the additive upstream of the injection point, wherein said additive pressure is modified by modifying the pressure of a pressurization fluid of a container containing said additive and communicating fluidly with said injection point.

16. The method as claimed in claim 15, the pressurization fluid pressure, called pressurization pressure, being determined according to
a pressure of said liquid in the pipe, and/or
an offset pressure, and/or
an additive pressure upstream of the injection point.

17. A method for renovating a storage and metering unit for injecting an additive into a pipe through which a liquid flows, the unit comprising
a container of which an inlet can be made to communicate fluidly with said pipe,
a flexible bag for containing said additive, placed inside the tank so as to undergo the pressure exerted by said liquid when said container inlet communicates with said pipe, and whereof an outlet can be made to communicate fluidly with said pipe, in particular by means of an injection system inserted into said pipe,
the method comprising the following steps:
a) detaching and extracting the bag from the container,
b) modifying the container inlet(s) and outlet(s) and installing a differential pressure controller, and optionally a pressure source, in order to constitute a storage and metering device as claimed in claim 1.
